(19) United States
(12) Patent Application Publication
(10) Pub. No.: US 2009/0031137 A1
(43) Pub. Date: Jan. 29, 2009

(54) BLIND SIGNATURE METHOD AND ITS SYSTEM

(75) Inventors: Satoshi Ishizaka, Tokyo (JP); Akihisa Tomita, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORORATION, Minato-ku (JP)

(21) Appl. No.: 12/162,901

(22) PCT Filed: Jan. 12, 2007
(86) PCT No.: PCT/JP2007/050294

§ 371 Date: Jul. 31, 2008

(30) Foreign Application Priority Data
Feb. 1, 2006 (JP) 2006-024328

(51) Int. Cl. H04L 9/00

(52) U.S. Cl. 713/180

(57) ABSTRACT

Signature requestor terminal device (10) codes a plurality of messages to a quantum state and transmits it to signer terminal device (20). Signer terminal device (20) issues a blind signature for the plurality of the messages coded to the quantum state, codes the messages and the signature to a quantum state and sends them back to signature requestor terminal device (10).

### TECHNICAL FIELD

The present invention relates to a blind signature method and its system for allowing a signer to issue a blind digital signature, in which the contents of a message are disguised, and which is to be affixed to electronic information.

### BACKGROUND ART

A blind signature is a technique for allowing the signer to issue a signature in which the contents of a message are disguised. A method based on RSA signature was described in a document by D. Chaum, “Security without Identification: Transaction Systems to Make Big Brother Obsolete”, Communication of the ACM, Vol. 28, No. 10, pp. 1030-1044 (1985) and in U.S. Pat. No. 4,759,063. The method will be outlined as follows:

Assume that a secret key of the signer is d and that a public key is (e,n), where d, e and n are integers that are chosen to satisfy t^{ed}=r mod n for any integer t. Also, assume that h is an appropriate hash function and f_{d} is a signature function f_{d}(x)=x^{d} mod n in the RSA signature.

First of all, the signature requester generates a random number r, and computes X=r^{e}h(M) mod n, using the message M and the public key e for the signer. The signature requestor sends this blind message X to the signer. At this time, the message M is randomized by the random number r, and the signer cannot know the contents of the original message M from the blind message X.

Upon receipt of the original message X, the signer calculates Y=f_{d}(X) from the blind message X and the secret key d and sends back Y to the signature requestor.

The signature requestor calculates S=Y/r mod n using the previously generated random number r. At this time, if S=h(M)^{d} mod n holds from the relationship of t^{ed}=t mod n, S is the correct RSA signature for the message M.

The conventional blind signature method makes use of the signature function f in the RSA signature having a multiplicative property of f_{d}(xy)=f_{d}(x)f_{d}(y). In this way, the signature function usable for the blind signature method is required to have a special mathematical property such as a multiplicative property, and has a problem in which any signature function cannot always be used for the blind signature.

### DISCLOSURE OF THE INVENTION

It is an object of the invention to provide a blind signature method and system that can use any signature function for the blind signature.

In order to accomplish the above object, according to the invention, the signature requestor terminal device codes a plurality of message candidates to one first quantum state, the signature requestor terminal device sends the first quantum state via a quantum communication path to the signer terminal device, the signer terminal device issues a signature for the plurality of message candidates to the first quantum state that uses the signature function and that generates one second quantum state in which the plurality of message candidates and the plurality of signatures are coded, the signer terminal device sends back the second quantum state via the quantum communication path to the signature requestor terminal device, and the signature requestor terminal device measures the second quantum state, specifying one message among the plurality of message candidates and obtaining the signature for the message.

In the invention as configured above, a plurality of message candidates are generated and coded to the first quantum state by quantum coding means at the signature requestor terminal device. The first quantum state is the superposed state in which the plurality of message candidates are coded. The signature requestor terminal device sends the first quantum state to the signer terminal device, using quantum communication means. At this time, if the first quantum state is measured to specify the message candidate at the signature requestor terminal device, the quantum state superposition is abandoned, causing the first quantum state to transit to another quantum state. In this way, since the plurality of message candidates are coded to one quantum state, the message cannot be specified without any trace remaining at the signer terminal device. On the other hand, at the signer terminal device, the first quantum state is inputted into the quantum calculation means, which calculates the signature function, whereby it is possible to issue the signature for the plurality of message candidates without specifying the message, and to generate one second quantum state in which both the plurality of message candidates and the plurality of signatures for the plurality of message candidates are coded. The second quantum state is the superposed state in which the quantum state of the coded message and the quantum state of the coded signature are entangled. The quantum communication means at the signer terminal device sends the second quantum state to the signature requester terminal device. The signature requestor terminal device measures the second quantum state using the quantum measuring means. When the measurement result is one message among the message candidates, the signature requestor terminal device can measure the signature that corresponds to the message correctly owing to the entangled property of the second quantum state. In this way, the signature requestor can obtain the signature on the message without the message being known by the signer.

As described above, in the invention, any signature function can be used for the blind signature. That is, at the signature requestor terminal device, it is possible to obtain a signature that has any signature function without the contents of the message being known by the signer.

### BRIEF DESCRIPTION OF THE DRAWINGS

FIG. 1 is a view showing a blind signature system according to a first exemplary embodiment of the present invention;

FIG. 2 is a flowchart for explaining a blind signature method for the blind signature system as shown in FIG. 1;

FIG. 3 is a view showing a blind signature system according to a second exemplary embodiment of the invention; and

FIG. 4 is a flowchart for explaining a blind signature method for the blind signature system as shown in FIG. 3.

### BEST MODE FOR CARRYING OUT THE INVENTION

### First Exemplary Embodiment

FIG. 1 is a view showing a blind signature system according to a first exemplary embodiment of the present invention.

In this exemplary embodiment, signature requestor terminal device 10 that requests a signature on a message, and signer terminal device 20 that issues the signature to the message provided by signature requester terminal device 10 that uses a signature function are connected via quantum communication path 30, in which signature requestor terminal device 10 comprises first quantum communication means 11, quantum coding means 12 and quantum measuring means 13, and signer terminal device 20 comprises second quantum communication means 21 and quantum calculation means 22, as shown in FIG. 1.

Quantum coding means 12 codes a plurality of message candidates to one first quantum state.

Quantum communication means 11 sends the first quantum state via quantum communication path 30 to signer terminal device 20.

Quantum measuring means 13 measures a second quantum state sent from signer terminal device 20, in which the plurality of message candidates and a plurality of signatures for the plurality of message candidates are coded, to specify one message among the plurality of message candidates, and to obtain the signature on that message.

Quantum calculation means 22 issues the signature for each of the plurality of message candidates in the first quantum state using the signature function, and generates a second quantum state in which the plurality of message candidates and the plurality of signatures are coded.

Quantum communication means 21 sends back the second quantum state via quantum communication path 30 to signature requestor terminal device 10.

Next, a blind signature method for the blind signature system as configured above will be described below.

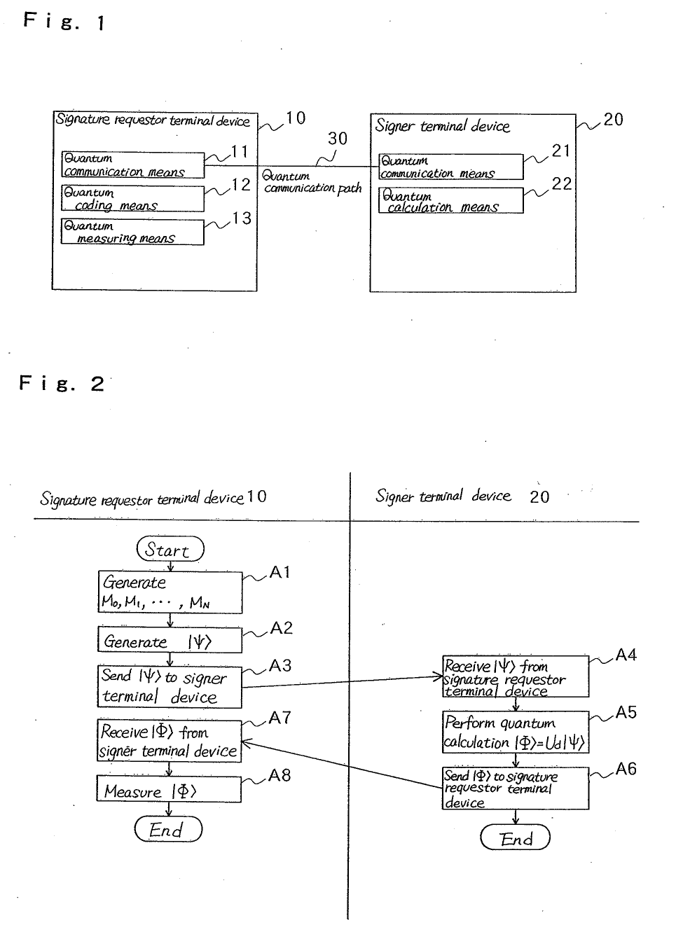

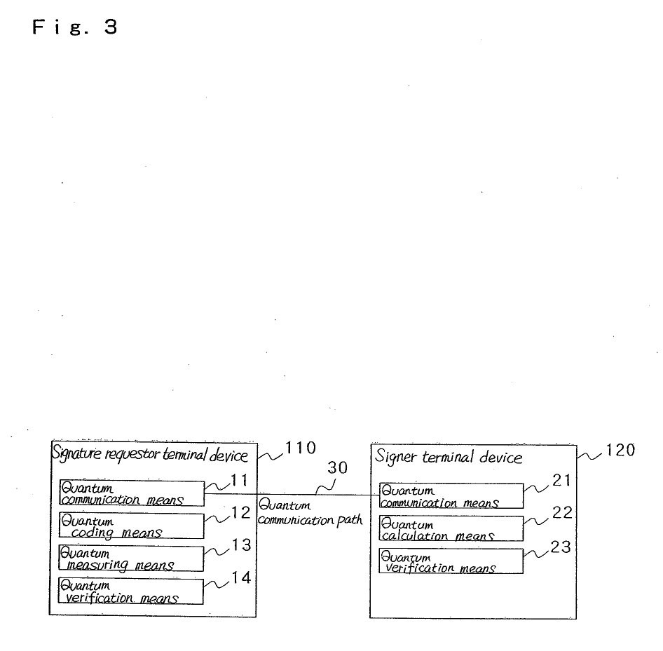

FIG. 2 is a flowchart for explaining the blind signature method for the blind signature system as shown in FIG. 1. The signature S that signer terminal device 20 issues for message M is represented as S=f_{d}(M) using the signature function f_{d}. In the invention, any signature function can be used, and is not limited to the specific form of f_{d}. Also, the quantum state in which message Mᵢ is coded is represented as |Mᵢ>, and the quantum state in which signature Sᵢ is coded is represented as |Sᵢ>. The quantum state in which both message Mᵢ and signature Sᵢ are coded is represented as |Mᵢ>|Sᵢ>.

First, signature requestor terminal device 10 generates a plurality of message candidates {M₁, M₂, M₃, . . . , M_{N}} (step A1), where the number of message candidates is N≧2.

Then, quantum coding means 12 at signature requestor terminal device 10 generates a first quantum state |ψ> in which the plurality of message candidates {M₁, M₂, M₃, . . . , M_{N}} are coded (step A2).

$$\vert Ψ 〉 = \frac{1}{\sqrt{N}} ( \vert {M}_{1} 〉 + \vert {M}_{2} 〉 + … + \vert {M}_{N} 〉 ) \qquad [ Formula 1 ]$$

Then, quantum communication means 11 at signature requestor terminal device 10 sends the quantum state |ψ> via quantum communication path 30 to signer terminal device 20 (step A3).

Quantum communication means 21 at signer terminal device 20 receives the quantum state |ψ> sent from signature requestor terminal device 10 (step A4).

Signer terminal device 20 has quantum calculation means 22 that outputs the quantum state M>f_{d}(M)> for the input of the quantum state |M>. The operation of a quantum computer that realizes quantum calculation means 22 is represented as |M>|f_{d}(M)>=U_{d}|M> where U_{d} is a unitary transformation matrix. Signer terminal device 20 inputs the received quantum state |ψ> into quantum calculation means 22, and obtains a second quantum state U_{d}|ψ> as the output (step A5).

$$\begin{matrix}{U}_{d} \vert Ψ 〉 = \frac{1}{\sqrt{N}} {U}_{d} ( \vert {M}_{1} 〉 + \vert {M}_{2} 〉 + … + \vert {M}_{N} 〉 ) \\ = \frac{1}{\sqrt{N}} ( \vert {M}_{1} 〉 \vert {S}_{1} 〉 + \vert {M}_{2} 〉 \vert {S}_{2} 〉 + … + \vert {M}_{N} 〉 \vert {S}_{N} 〉 ) \\ = \vert Φ 〉\end{matrix} \qquad [ Formula 2 ]$$

Then, quantum communication means 21 at signer terminal device 20 sends the quantum state |Φ> via quantum communication path 30 to signature requestor terminal device 10 (step A6).

Quantum communication means 11 at signature requestor terminal device 10 receives the quantum state |Φ> sent from signer terminal device 20 (step A7). At this time, the quantum state ID> is

$$\vert Φ 〉 = \frac{I}{\sqrt{N}} ( \vert {M}_{1} 〉 \vert {S}_{1} 〉 + \vert {M}_{2} 〉 \vert {S}_{2} 〉 + … + \vert {M}_{N} 〉 \vert {S}_{N} 〉 ) \qquad [ Formula 3 ]$$

Thereafter, quantum measuring means 13 at signature requestor terminal device 10 measures the quantum state |Φ> (step A8). Supposing that the measurement result for a coded part of message is Mₓ where N≧x≧1, the quantum state |Φ> converges to |Φ>=|Mₓ>|Sₓ> with this measurement, whereby the measurement result for the coded part of the signature is necessarily Sₓ. The measurement results Mₓ and Sₓ are made the desired message and its corresponding signature, and the process is ended.

### Second Exemplary Embodiment

A process for detecting illegality of the signer or signature requestor anywhere in the processing flow may be added to the first exemplary embodiment. One example will be described below.

FIG. 3 is a view showing a blind signature system according to a second exemplary embodiment of the invention.

In this exemplary embodiment, unlike the first exemplary embodiment, signature requestor terminal device 110 is provided with first quantum verification means 14 and signer terminal device 120 is provided with second quantum verification means 23, as shown in FIG. 3.

Signature requestor terminal device 110 sends a plurality of message candidates via the ordinary communication line to signer terminal device 120.

Quantum coding means 12 at signature requestor terminal device 110 generates a third quantum state in which the plurality of message candidates and a plurality of signatures sent from signer terminal device 120 are coded.

Quantum verification means 14 at signature requestor terminal device 110 verifies whether or not signer terminal device 120 implies illegality by comparing the second quantum state and the third quantum state.

Signer terminal device 120 generates a fourth quantum state in which the plurality of message candidates sent from signature requestor terminal device 110 are coded.

Quantum verification means 23 at signer terminal device 120 verifies whether or not signature requestor terminal device implies illegality by comparing the first quantum state and the fourth quantum state.

Using quantum verification means 14 and 23, as in this exemplary embodiment, it can be found that, at a certain probability, two quantum states are not the same. Also, if two quantum states are the same with quantum verification means 14 and 23, the two quantum states that have been verified, remain unchanged after verification. Such quantum verification means can be realized by a swap test as described in H. Buhrman, R. Cleve, J. Watrous, R. de Wolf, “Quantum fingerprinting”, Physical Review Letters, Vol. 87, pp. 167902 (2001), for example.

Next, a blind signature method for the blind signature system as configured above will be described below.

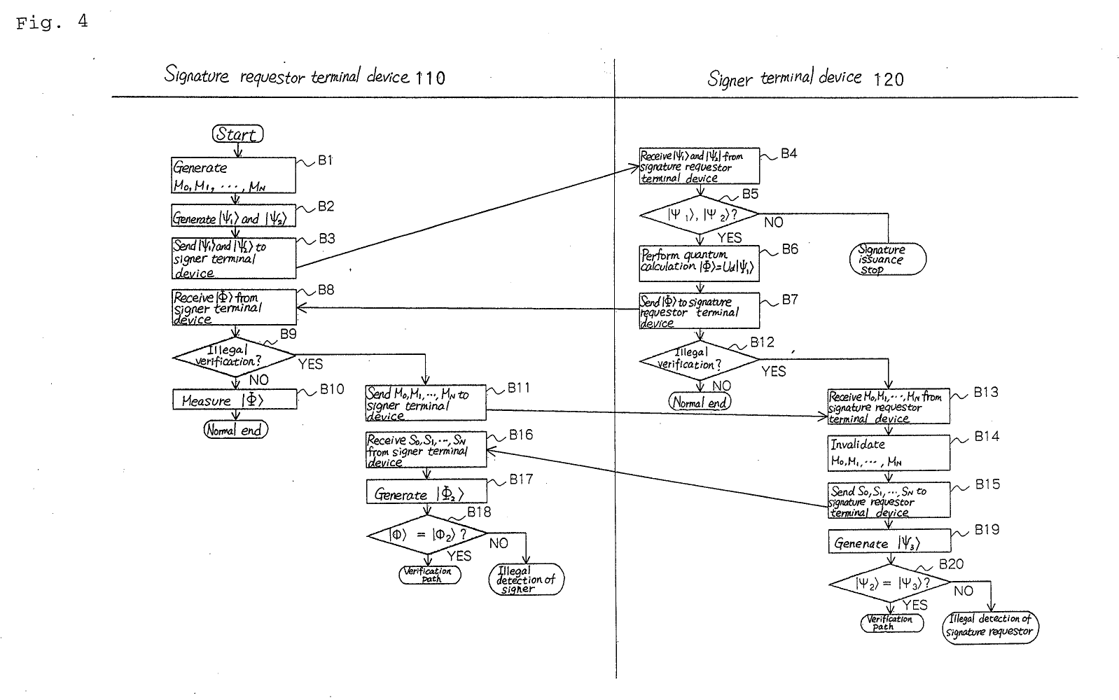

FIG. 4 is a flowchart for explaining the blind signature method for the blind signature system as shown in FIG. 3.

First, signature requestor terminal device 110 generates a plurality of message candidates {M₁, M₂, M₃, . . . , M_{N}} (step B1), where the number of message candidates is N>2.

Then, quantum coding means 12 at signature requestor terminal device 110 generates the quantum states |ψᵢ> and |ψ₂> in which the plurality of message candidates {M₁, M₂, M₃, . . . , M_{N}} are coded (step B2). The quantum states |ψ₁> and |ψ₂> are exactly the same as the state |ψ> at step A2 in the first exemplary embodiment.

Then, quantum communication means 11 at signature requestor terminal device 110 sends the quantum states |ψ₁> and |ψ₂> via quantum communication path 30 to signer terminal device 120 (step B3).

Quantum communication means 21 at signer terminal device 120 receives two quantum states |ψ₁> and |ψ₂> sent from signature requestor terminal device 10 (step B4).

Then, quantum verification means 23 at signer terminal device 120 investigates whether or not two quantum states |ψ₁> and |ψ2> are the same (step B5). If the results of investigation indicate that they are not the same, issuance of the signature is stopped.

If two quantum states |ψ₁> and |ψ₂> are the same, the quantum state |ψ₁> is inputted into quantum calculation means 22 at signer terminal device 120, and the quantum state |Φ> is obtained as the output in the same way as shown in the first exemplary embodiment (step B6).

Then, quantum communication means 21 at signer terminal device 120 sends back the quantum state |Φ> via quantum communication path 30 to signature requester terminal device 110 (step B7).

Quantum communication means 11 at signature requestor terminal device 110 receives the quantum state |Φ> sent back from signer terminal device 120 (step B8).

Thereafter, it is determined whether or not the flow for verifying the illegality is entered. If it is determined that the illegality verification flow is not entered at signature requestor terminal device 110 or at signer terminal device 120 (step B9), quantum measuring means 13 at signature requestor terminal device 110 measures the quantum state |Φ> in the same way as shown in the first exemplary embodiment, and the measurement results Mₓ and Sₓ are made the desired message and its signature and the process is normally ended (step B10).

Also, if it is determined that the illegality verification flow has been entered, signature requestor terminal device 110 sends the plurality of message candidates {M₁, M₂, M₃, . . . , M_{N}} via the ordinary communication line to signer terminal device 120 (step B11).

If it is determined that the illegality verification flow has been entered (step B12), signer terminal device 120 receives the plurality of message candidates {M₁, M₂, M₃, . . . , M_{N}} sent from signature requestor terminal device 110 (step B13).

And the received message candidates {M₁, M₂, M₃, . . . , M_{N}} are recorded as invalid and released (step B14).

Also, signer terminal device 120 calculates the signatures for the message candidates {M₁, M₂, M₃, . . . , M_{N}}, using the signature function f_{d}, and sends the signatures {S₁, S₂, S₃, . . . , S_{N}} via the ordinary communication line to signature requestor terminal device 110 (step B15).

Signature requestor terminal device 110 receives the signatures {S₁, S₂, S₃, . . . , S_{N}} for the message candidates {M₁, M₂, M₃, . . . , M_{N}} sent from signer terminal device 120 (step B16).

Then, quantum coding means 12 at signature requestor terminal device 110 generates a third quantum state |Φ₂>using the received signatures {S₁, S₂, S₃, . . . , S_{N}} (step B17).

$$\vert {Φ}_{2} 〉 = \frac{1}{\sqrt{N}} ( \vert {M}_{1} 〉 \vert {S}_{1} 〉 + \vert {M}_{2} 〉 \vert {S}_{2} 〉 + … + \vert {M}_{N} 〉 \vert {S}_{N} 〉 ) \qquad [ Formula 4 ]$$

Then quantum verification means 14 investigates whether or not the quantum states |Φ> and |Φ₂> are the same quantum state (step B18). If the results of investigation indicate that the quantum states are the same, the verification flow is passed and once ended, and the request for signature is retried from step B1. If the results of the investigation indicate that the quantum states are not the same, the signer is declared as illegal.

Also, signer terminal device 20 generates a fourth quantum state 113>using the received message candidates {M₁, M₂, M₃, . . . , M_{N}} (step B19).

$$\vert {Ψ}_{3} 〉 = \frac{1}{\sqrt{N}} ( \vert {M}_{1} 〉 + \vert {M}_{2} 〉 + … + \vert {M}_{N} 〉 ) \qquad [ Formula 5 ]$$

Next quantum verification means 23 investigates whether or not the quantum states |ψ₂> and |ψ₃> are the same quantum state (step B20). If the results of investigation indicate that the quantum states are the same, the verification flow is passed and ended. If the results of investigation indicate that the quantum states are not the same, the illegality of the signature requestor is declared.

In this exemplary embodiment, if the signer tries to specify the message illegally, signature requestor terminal device 110 can detect an illegal trace remaining in the quantum state probabilistically. Also, if the signature requester tries to obtain the signature illegally using the illegality verification process, the illegality is detected probabilistically by signer terminal device 120.

The illegality verification method of the invention is not limited to this method.

1. A blind signature method for issuing a signature to a message given from a signature requester terminal device using a signature function at a signer terminal device, comprising:
coding a plurality of message candidates to one first quantum state at said signature requestor terminal device;
sending said first quantum state from said signature requestor terminal device via a quantum communication path to said signer terminal device;
issuing a signature for said plurality of message candidates to said first quantum state using said signature function and generating one second quantum state in which said plurality of message candidates and said plurality of signatures are coded at said signer terminal device;
sending back said second quantum state from said signer terminal device via said quantum communication path to said signature requestor terminal device; and
measuring said second quantum state, specifying one message among said plurality of message candidates and obtaining the signature for said message at said signature requestor terminal device.

2. The blind signature method according to claim 1, further comprising:
sending said plurality of message candidates from said signature requestor terminal device to said signer terminal device;
issuing a plurality of signatures for said plurality of message candidates using said signature function and sending said plurality of signatures from said signer terminal device to said signature requestor terminal device;
generating a third quantum state in which said plurality of message candidates and the plurality of signatures sent from said signer terminal device are coded at said signature requester terminal device; and
verifying whether or not said signature terminal device implies illegality by comparing said second quantum state and said third quantum state at said signer requestor terminal device.

3. The blind signature method according to claim 2, further comprising generating a fourth quantum state in which said plurality of message candidates sent from said signature requestor terminal device are coded at said signer terminal device, and verifying whether or not said signature requestor terminal device implies illegality by comparing said first quantum state and said fourth quantum state at said signer terminal device.

4. A blind signature system comprising a signature requestor terminal device for requesting a signature to a message, and a signer terminal device for issuing the signature to the message given from said signature requestor terminal device using a signature function, said signature requestor terminal device comprising:
quantum coding means for coding a plurality of message candidates to one first quantum state;
first quantum communication means for sending said first quantum state via a quantum communication path to said signer terminal device; and
quantum measuring means for measuring a second quantum state in which said plurality of message candidates and a plurality of signatures for said plurality of message candidates are coded, specifying one message among said plurality of message candidates and obtaining the signature for said message; and
said signer terminal device comprising:
quantum calculation means for issuing the signature for said plurality of message candidates to said first quantum state using said signature function and generating said second quantum state in which said plurality of message candidates and the plurality of signatures are coded; and
second quantum communication means for sending back said second quantum state via said quantum communication path to said signature requestor terminal device.

5. The blind signature system according to claim 4, wherein
said signature requestor terminal device sends said plurality of message candidates to said signer terminal device,
said quantum coding means generates a third quantum state in which said plurality of message candidates and the plurality of signatures sent from said signer terminal device are coded, and
said signature requestor terminal device comprises first quantum verification means for verifying whether or not said signer terminal device implies illegality by comparing said second quantum state and said third quantum state.

6. The blind signature system according to claim 5, wherein
said signer terminal device generates a fourth quantum state in which said plurality of message candidates sent from said signature requestor terminal device are coded, and
said signer terminal device comprises second quantum verification means for verifying whether or not said signature requestor terminal device implies illegality by comparing said first quantum state and said fourth quantum state.
